(19) United States
(12) Patent Application Publication
(10) Pub. No.: US 2006/0150341 A1
(43) Pub. Date: Jul. 13, 2006

(54) Cup with combination caribiner and bottle opener

(76) Inventor: Lonnie F. Gary, Lubbock, TX (US)

Correspondence Address: LOCKE LIDDELL & SAPP LLP;ATTN: STACIE COX, 2200 ROSS AVENUE, SUITE 2200, DALLAS, TX, 75201-6776, US

(21) Appl. No.: 11/031,262

(22) Filed: Jan. 7, 2005

(51) Int. Cl. B67B 7/00; B25F 1/00

(52) U.S. Cl. 7/151

(57) ABSTRACT

A container or receptacle, preferably a drinking cup or glass, having attached a combination caribiner and bottle opener.

### BACKGROUND OF THE INVENTION

1. Field of the Invention

This invention relates to a container such as a drinking cup or glass that is releasably attachable to a belt, belt loop, backpack or other support member by means of a device that functions both as a caribiner for such attachment and as a bottle opener.

2. Description of Related Art

There are many circumstances where it is desirable to be able to attach a cup or glass to another garment or object, especially between uses, to prevent it from becoming lost or separated, or when outdoors, from being dropped to the ground. There are also many circumstances, particularly tailgate parties and other social gatherings, where a bottle opener is needed. An invention is needed that combines the three different utilities in a single, easily manageable article.

### SUMMARY OF THE INVENTION

The invention disclosed herein comprises a container or receptacle, most preferably a drinking cup or glass with or without a lid, that is attachable to another object by means of an article having the functional capabilities of both a caribiner and a bottle opener. The container portion of the invention is preferably made of metal, plastic, or any other similarly effective material that is resistant to breakage under the intended use conditions. The combination caribiner and bottle opener is preferably made of metal, a durable polymeric material, or a combination thereof, having sufficient strength and durability to support the container weight and to remove conventional crimped-on bottle caps. According to a particularly preferred embodiment of the invention, the combination caribiner and bottle opener is pivotally and releasably connected to the container or receptacle.

### BRIEF DESCRIPTION OF THE DRAWINGS

The apparatus of the invention is further described and explained in relation to the following drawings wherein:

FIG. 1 is a perspective view of a preferred embodiment of the subject cup and combination caribiner and bottle opener;

FIG. 2 is a right side elevation view of the invention as shown in FIG. 1;

FIG. 3 is an exploded side elevation view of the invention as shown in FIG. 2, but having the combination caribiner and bottle opener detached from the cup;

FIG. 4 is a front elevation view of the cup of FIG. 3;

FIG. 5 is a cross-sectional elevation view taken along line 5-5 of FIG. 3;

FIG. 6 is a cross-sectional elevation view taken along line 6-6 of FIG. 4;

FIG. 7 is a top plan view of a preferred embodiment of the combination caribiner and bottle opener of the invention;

FIG. 8 is a front elevation view of the combination caribiner and bottle opener of FIG. 7;

FIG. 9 is a bottom plan view of the combination caribiner and bottle opener of FIG. 8;

FIG. 10 is a right side elevation view of the combination caribiner and bottle opener of FIG. 8; and

FIG. 11 is an enlarged elevation view, partially in section, taken along line 11-11 of FIG. 8.

### DESCRIPTION OF THE PREFERRED EMBODIMENTS

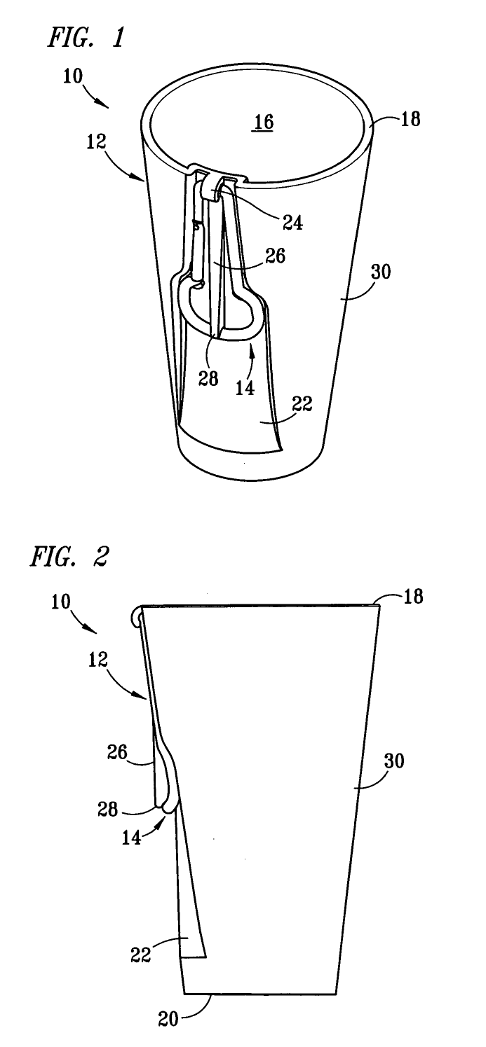

FIGS. 1-3 depict a preferred embodiment of receptacle 10 of the invention, which principally comprises drinking cup 12 and caribiner 14. Drinking cup 12 preferably further comprises sidewall 30 having top edge 18, bottom 20, and interior space 16. Sidewall 30 preferably further comprises a recess 22 into which caribiner 14 can be folded for storage when cup 12 is being used for drinking. In the folded position, caribiner 14 is preferably frictionally engaged by top hook 24 and bottom shoulder 28 of rib 26.

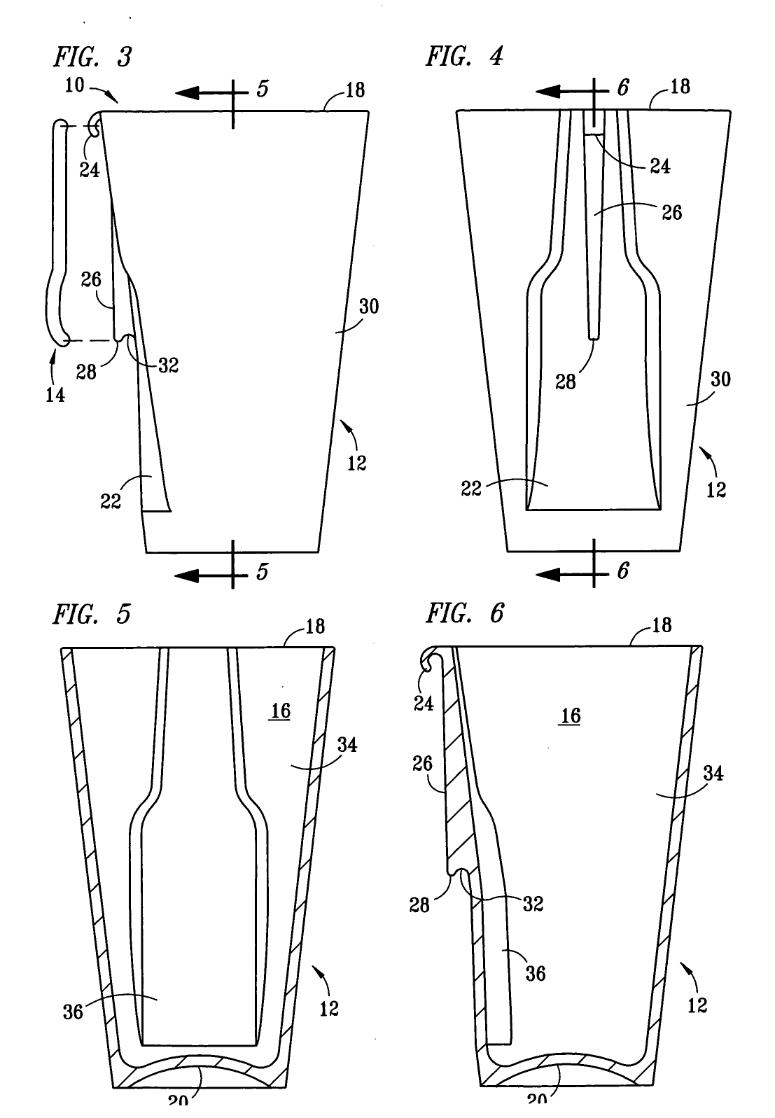

Referring to FIG. 1, caribiner 14 can be released from recess 32 behind bottom shoulder 28 of rib 26 by grasping the downwardly extending portion of caribiner 14 and pulling it outwardly past shoulder 28, after which caribiner 14 can be pivoted upwardly under top hook 24 to permit use of caribiner 14 either as a bottle opener or for attaching caribiner 14 to an external carrier or support member (not shown) for transportation or storage of cup 12. If desired, as shown in FIG. 3, caribiner 14 can also be detached from cup 12 by exerting manual force to overcome the frictional engagement between it and top hook 24. FIG. 4 depicts a front elevation view of cup 12 with caribiner 14 detached.

FIG. 5 is a cross-sectional elevation view that further depicts inside wall 34 of cup 12, including rear surface 36 of recess 22. FIG. 6 is another cross-sectional elevation view, transverse to FIG. 5, that further depicts preferred profile geometry for top hook 24 and bottom shoulder 28 of rib 26 of cup 12.

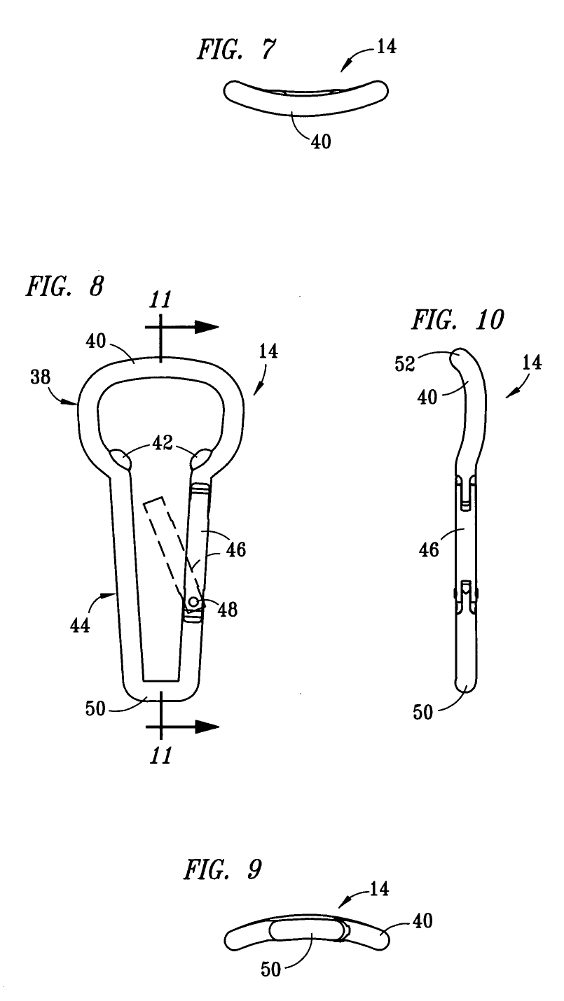

A preferred embodiment of caribiner 14 is further described and explained in relation to FIGS. 7-11, and preferably comprises bottle opener section 38 and clip section 44. Bottle opener section 38 preferably comprises head loop 40, sized to engage the top of a crimped-on bottle cap, and opposed, spaced-apart projections 42 that are engageable beneath the circumferentially extending skirt portion of a conventional bottle cap (not shown) and cooperate with head loop 40 to permit easy removal of the cap from the bottle with the application of minimal-to-moderate manual force. When caribiner 14 is used in such manner, clip section 44 serves as a handle for the bottle opener. At the preference of the user, caribiner 14 can either be detached from cup 12 (FIG. 1) or simply pivoted upwardly relative to top hook 24 to permit use as a bottle opener while still attached to cup 12 as desired. Alternatively, it will be appreciated that caribiner 14 can be permanently attached to cup 12 if desired by substituting a permanent loop in place of top hook 24, or by the use of any other similarly effective known mechanical means.

Referring to FIGS. 8, 10 and 11, clip section 44 of caribiner 14 preferably further comprises inwardly tapering side sections connected at their lower ends by bottom segment 50. (As shown in FIG. 1, bottom segment 50 is the portion of caribiner 14 that is frictionally held by bottom shoulder 28 of rib 26, so that the center portion of bottom segment 50 rests in recess 32 when caribiner 14 is folded into recess 22 of cup 12.) Clip 46 is preferably pivotably connected by pin 48 to the rest of caribiner 14, and can be pivoted inwardly as shown in dashed outline in FIG. 8 to permit attachment of caribiner 14 to a loop, eyebolt, strap, belt, garment, or the like (not shown) for use in attaching cup 12 to a carrier or support member.

Although caribiner 14 is not shown as being attached to cup 12 in FIG. 8, it will be apparent to those of skill in the art upon reading this disclosure that clip 46 can be flexed inwardly to secure caribiner 14 to a support structure or carrier even while attached to cup 12 if pivoted upwardly around top hook 24 from the tucked position as shown in FIG. 1. Clip 46 of caribiner 14 is desirably biased toward the closed position so that caribiner 14 will remain attached to a carrier or support member until manually removed by the user. According to a particularly preferred embodiment, a spring (not shown) disposed inside a bore in clip 46 is used to bias clip 46 to the closed position as shown in solid outline in FIG. 8. Caribiners having spring clips biased to the closed position are commercially available but are not known to further comprise a bottle opener section 38 as disclosed herein. By combining the two in further combination with a drinking cup or other receptacle or container, users can reduce the number of separate items needed to be transported, stored and handled.

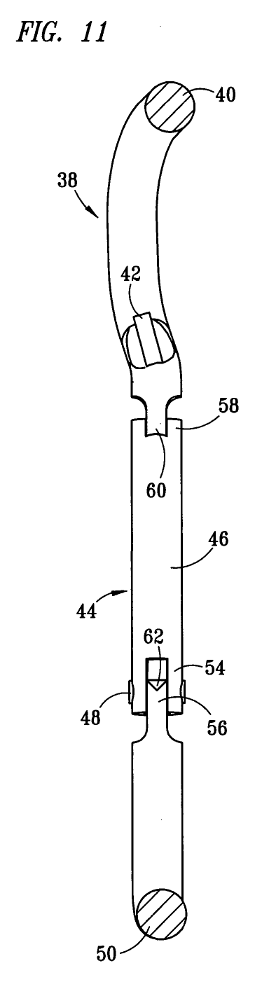

FIG. 11 is an enlarged, partial cross-sectional detail view of one side of a preferred caribiner 14 for use in the invention that better illustrates head loop and one projection 42, and tongue 60 of bottle cap section 38, and bottom 50, tongue 56, devises 54, 58 of clip 46, and pin 48 of clip section 44.

Other alterations and modifications of the invention will likewise become apparent to those of ordinary skill in the art upon reading this specification in view of the accompanying drawings, and it is intended that the scope of the invention disclosed herein be limited only by the broadest interpretation of the appended claims to which the inventor is legally entitled.

We claim:

1. A receptacle for liquids, the receptacle having bottom and side walls, an upwardly facing opening, and an attached caribiner, the caribiner further comprising a bottle opener.

2. The receptacle of claim 1 wherein the caribiner is pivotally attached to the receptacle.

3. The receptacle of claim 1 wherein the caribiner is detachable from the receptacle.

4. The receptacle of claim 1 wherein the cup is made of metal, polymeric material, or a combination thereof.

5. The receptacle of claim 1 wherein the caribiner is made of metal, polymeric material, or a combination thereof.

6. The receptacle of claim 1 wherein the sidewall comprises a recess into which at least a portion of the caribiner is receivable.

7. The receptacle of claim 1, comprising at least one structural member that is frictionally engageable with the caribiner.

8. The receptacle of claim 7 wherein the caribiner has two ends, and each end is frictionally engageable with a portion of the receptacle.

9. The receptacle of claim 1 wherein the caribiner has a pivotally connected clip member.

10. The receptacle of claim 9 wherein the clip member is biased into a closed position.

11. A drinking cup having attached to it a combination caribiner and bottle opener.

12. The drinking cup of claim 11 wherein the caribiner is pivotally attached to the cup.

13. The drinking cup of claim 11 wherein the caribiner is detachable from the cup.

14. The drinking cup of claim 11 wherein the cup is made of metal, polymeric material, or a combination thereof.

15. The drinking cup of claim 1 wherein the caribiner is made of metal, polymeric material, or a combination thereof.

16. The drinking cup of claim 1 wherein the sidewall comprises a recess into which at least a portion of the caribiner is receivable.

17. The drinking cup of claim 1, comprising at least one structural member that is frictionally engageable with the caribiner.

18. The drinking cup of claim 7 wherein the caribiner has two ends, and each end is frictionally engageable with a portion of the cup.

19. The drinking cup of claim 1 wherein the caribiner has a pivotally connected clip member.

20. The drinking cup of claim 19 wherein the clip member is biased into a closed position.
